(19) United States
(12) Patent Application Publication
(10) Pub. No.: US 2024/0085749 A1
(43) Pub. Date: Mar. 14, 2024

(54) ELECTRO-OPTICAL DEVICE AND ELECTRONIC APPARATUS

(71) Applicant: SEIKO EPSON CORPORATION, Tokyo (JP)

(72) Inventor: Masahito YOSHII, CHITOSE-SHI (JP)

(73) Assignee: SEIKO EPSON CORPORATION, Tokyo (JP)

(21) Appl. No.: 18/464,251

(22) Filed: Sep. 10, 2023

(30) Foreign Application Priority Data
Sep. 13, 2022 (JP) 2022-145095

(51) Int. Cl. G02F 1/1362; G02F 1/1335

(52) U.S. Cl. CPC G02F 1/136227; G02F 1/133526; G02F 1/136209; G02F 1/13685

(57) ABSTRACT

A liquid crystal device includes a transistor, a pixel electrode provided corresponding to the transistor, a lens layer provided in a layer between the transistor and the pixel electrode, a relay layer provided in a layer between the transistor and the lens layer, and a contact plug configured to electrically connect the relay layer and the pixel electrode, and a part of the contact plug is provided in the relay layer.

The present application is based on, and claims priority from JP Application Serial Number 2022-145095, filed Sep. 13, 2022, the disclosure of which is hereby incorporated by reference herein in its entirety.

### BACKGROUND

### 1. Technical Field

The present disclosure relates to an electro-optical device and an electronic apparatus including the electro-optical device.

### 2. Related Art

JP-A-2019-139252 discloses an electro-optical device including a pixel electrode formed at a substrate body of an element substrate, a switching element formed between the pixel electrode and the substrate, and a lens formed between the pixel electrode and the switching element.

In JP-A-2019-139252, a depth of a contact hole for electrically connecting the pixel electrode and the switching element is smaller than a depth of a concave surface for a lens.

This configuration prevents reliability of the electrical connection from deteriorating due to an increase in an aspect ratio of the contact hole, and for this reason, a relay electrode that relays the contact hole is provided at a position shallower than the bottom of the concave surface for a lens between adjacent lenses.

Through experiments, prototypes, and the like by the inventors of the present application, the inventors have found that, when a relay electrode is formed between adjacent lenses at a position shallower than the bottom of a concave surface for a lens, optical performance of the lens may be affected.

An advantage of some aspects of the disclosure is to provide an electro-optical device capable of achieving both optical performance of a lens and reliability of electrical connection between a pixel electrode and a switching element.

### SUMMARY

An electro-optical device according to an aspect of the present application includes a transistor, a pixel electrode provided corresponding to the transistor, a lens layer provided in a layer between the transistor and the pixel electrode, a first relay layer provided in a layer between the transistor and the lens layer, and a first connecting member configured to electrically connect the first relay layer and the pixel electrode, wherein a part of the first connecting member is provided inside the first relay layer.

An electronic apparatus according to an aspect of the present disclosure includes the electro-optical device described above.

### BRIEF DESCRIPTION OF THE DRAWINGS

FIG. 1 is a plan view of an electro-optical device according to Embodiment 1.

FIG. 2 is a cross-sectional view of the electro-optical device taken along line II-II in FIG. 1.

FIG. 3 is an equivalent circuit diagram illustrating an electrical configuration of an element substrate.

FIG. 4 is an explanatory diagram illustrating a cross-sectional structure of a display region of the element substrate.

FIG. 5 is a plan view illustrating a part of the display region of the element substrate.

FIG. 6 is a cross-sectional view taken along line VI-VI in FIG. 5.

FIG. 7 is a plan view illustrating a part of the display region of the element substrate.

FIG. 8 is a plan view illustrating a part of the display region of the element substrate.

FIG. 9 is a plan view illustrating a part of the display region of the element substrate.

FIG. 10 is a plan view illustrating a part of the display region of the element substrate.

FIG. 11 is a plan view illustrating a part of the display region of the element substrate.

FIG. 12 is an explanatory diagram illustrating a cross-sectional structure of an outer region of the element substrate.

FIG. 13 is a plan view illustrating a part of the outer region of the element substrate.

FIG. 14 is a cross-sectional view illustrating a part of a sectional structure taken along line XIV-XIV in FIG. 13.

FIG. 15 is a plan view illustrating a part of a display region of an element substrate according to Embodiment 2.

FIG. 16 is a schematic diagram illustrating an example of an electronic apparatus according to Embodiment 3.

### DESCRIPTION OF EMBODIMENTS

Embodiments of the present disclosure will be described below with reference to the accompanying drawings.

In the following drawings, the dimensions of some components may be scaled differently for ease of understanding for the components.

Further, hereinafter, for convenience of explanation, the description will be made appropriately using an X-axis, a Y-axis, and a Z-axis orthogonal to each other. Also, one direction along the X-axis is referred to as an X1 direction, and a direction opposite to the X1 direction is referred to as an X2 direction. Similarly, one direction along the Y-axis is referred to as a Y1 direction, and a direction opposite to the Y1 direction is referred to as a Y2 direction. One direction along the Z-axis is referred to as a Z1 direction, and a direction opposite to the Z1 direction is referred to as a Z2 direction. Further, in the following description, viewing in the Z1 direction or the Z2 direction is referred to as “plan view”, and viewing in a direction perpendicular to a cross-section including the Z-axis is referred to as “cross-sectional view”.

Further, in the following description, for example, with respect to a substrate, the description “on the substrate” means any of a case in which the element is disposed on the substrate in contact therewith, a case in which the element is disposed on the substrate with another structure interposed therebetween, and a case in which the element is partially disposed on the substrate in contact therewith and partially disposed with another structure interposed therebetween. In addition, the description of an upper surface of a certain configuration indicates a surface of the configuration on the side on the Z1 direction side, for example, an “upper surface of a light transmitting layer” indicates a surface of the light transmitting layer on the side on the Z1 direction side. In addition, the description of a bottom surface of a certain configuration indicates a surface of the configuration on the side in the Z2 direction, for example, a “bottom surface of a contact plug” indicates a surface of the contact plug on the side in the Z2 direction.

### 1. Embodiment 1

In the embodiment, as an electro-optical device, an active drive liquid crystal device having a thin film transistor (TFT) being a switching element for each of pixels will be described as an example. The liquid crystal device is used, for example, as a light modulation device in a projection type display device as an electronic apparatus which will be described below.

1.1. Outline of Structure of Liquid Crystal Device

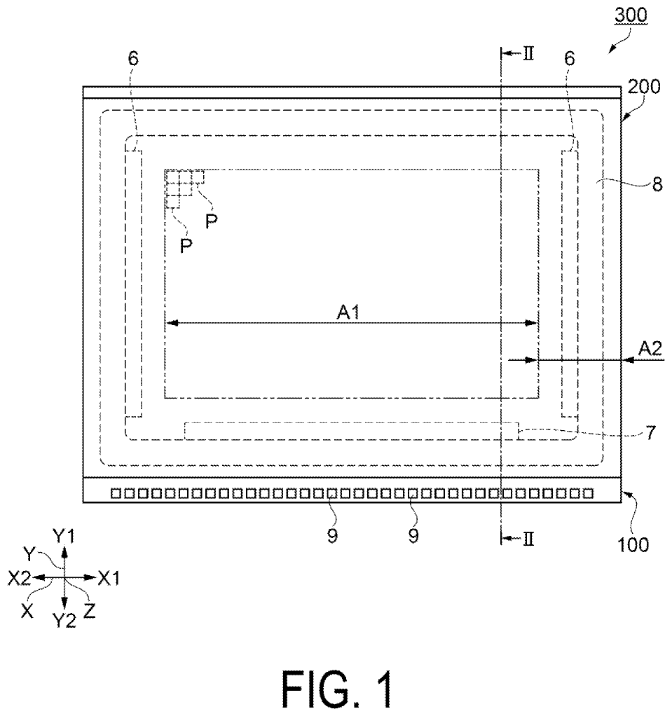

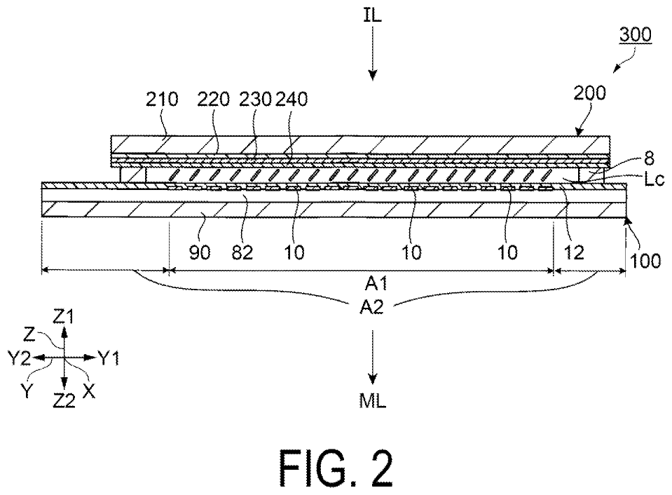

A structure of a liquid crystal device as an electro-optical device according to the embodiment will be described with reference to FIGS. 1 and 2. FIG. 1 is a plan view of an electro-optical device according to Embodiment 1, and illustrates a schematic plan configuration of a transmissive liquid crystal device 300 as the electro-optical device. FIG. 2 is a cross-sectional view of the electro-optical device taken along line II-II in FIG. 1, and illustrates a schematic cross-sectional configuration of the liquid crystal device 300.

As illustrated in FIGS. 1 and 2, the liquid crystal device 300 includes an element substrate 100 having a light transmitting property, a counter substrate 200 having a light transmitting property, a frame-shaped sealing member 8, and a liquid crystal layer Lc. The term “light transmitting property” refers to transparency to visible light, and means that a transmittance of visible light is preferably 50% or more.

The liquid crystal device 300 includes a display region A1 for displaying an image and an outer region A2 located outside the display region A1 in plan view. A plurality of pixels P arranged in a matrix pattern are provided in the display region A1. Although a shape of the liquid crystal device 300 illustrated in FIG. 1 is quadrangular, it may be circular, for example.

As illustrated in FIG. 2, the element substrate 100 and the counter substrate 200 are disposed with the liquid crystal layer Lc interposed therebetween.

In the embodiment, the counter substrate 200 is disposed on the light incident side of the liquid crystal layer Lc, and the element substrate 100 is disposed on the light emitting side of the liquid crystal layer Lc. Incident light IL incident on the counter substrate 200 is modulated by the liquid crystal layer Lc and is emitted from the element substrate 100 as modulated light ML.

The element substrate 100 includes a base body 90, a plurality of interlayer insulating layers including an interlayer insulating layer 82, a pixel electrode 10, and an alignment film 12. Although not illustrated, a lens layer 34 which will be described below is provided between the pixel electrode 10 and the interlayer insulating layer 82.

The base body 90 is a flat plate having a light transmitting property and an insulation property. The base body 90 is, for example, a glass substrate or a quartz substrate. The transistor 1 which will be described below is disposed between the plurality of interlayer insulating layers.

The pixel electrode 10 has a light transmitting property. The pixel electrode 10 includes a transparent conductive material such as indium tin oxide (ITO), indium zinc oxide (IZO) and fluorine-doped tin oxide (FTO).

A thickness-wise direction of the pixel electrode 10 coincides with the Z1 direction or the Z2 direction. The alignment film 12 has a light transmitting property and an insulation property. The alignment film 12 aligns liquid crystal molecules of the liquid crystal layer Lc. Examples of a material of the alignment film 12 include silicon oxide and polyimide.

The counter substrate 200 is a substrate disposed to face the element substrate 100. The counter substrate 200 has a base body 210, an insulating layer 220, a common electrode 230 and an alignment film 240.

The base body 210 is a flat plate having a light transmitting property and an insulation property. The base body 210 is, for example, a glass substrate or a quartz substrate. The insulating layer 220 has a light transmitting property and an insulating property. A material of the insulating layer 220 is an inorganic material such as silicon oxide. The common electrode 230 is an electrode disposed to face a plurality of pixel electrodes 10, and is also referred to as a counter electrode. The common electrode 230 includes a transparent conductive material such as ITO, IZO, and FTO. The common electrode 230 and the pixel electrode 10 apply an electric field to the liquid crystal layer Lc. The alignment film 240 has a light transmitting property and an insulating property.

The sealing member 8 is disposed between the element substrate 100 and the counter substrate 200. The sealing member 8 is formed using an adhesive containing various types of curable resins such as epoxy resin, for example. The sealing member 8 may include a gap material made of an inorganic material such as glass.

The liquid crystal layer Lc is disposed in a region surrounded by the element substrate 100, the counter substrate 200, and the sealing member 8. The liquid crystal layer Lc is disposed between the plurality of pixel electrodes 10 and the common electrode 230. The liquid crystal layer Lc is an electro-optical layer of which optical characteristics change in accordance with an electric field. The liquid crystal layer Lc contains liquid crystal molecules having positive or negative dielectric anisotropy. The alignment of the liquid crystal molecules changes according to an electric field applied to the liquid crystal layer Lc. The liquid crystal layer Lc modulates the incident light IL in accordance with the applied electric field.

As illustrated in FIG. 1, a plurality of scanning line driving circuits 6, a data line driving circuit 7, and a plurality of external terminals 9 are disposed in the outer region A2 of the element substrate 100. Some of the plurality of external terminals 9 are connected to the scanning line driving circuit 6 or the data line driving circuit 7 via wiring (not illustrated). Further, the plurality of external terminals 9 include a terminal to which a common potential is applied from the outside.

1.2. Electrical Configuration of Element Substrate

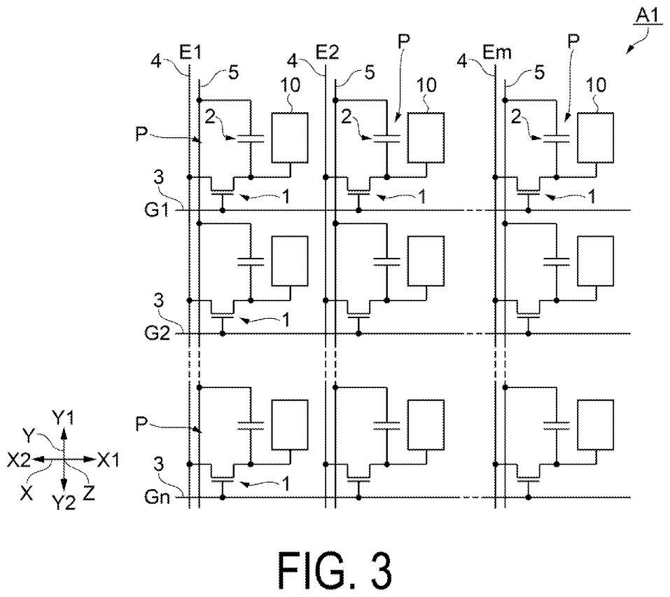

FIG. 3 is an equivalent circuit diagram illustrating an electrical configuration of the element substrate.

As illustrated in FIG. 3, a plurality of transistors 1 as switching elements, n scanning lines 3, m data lines 4, and n capacitance lines 5 are provided in the display region A1 of the element substrate 100. Both n and m are integers of 2 or greater. The transistors 1 are disposed corresponding to each intersection of n scanning lines 3 and m data lines 4.

Each of the n scanning lines 3 extends in the X1 direction, and the n scanning lines 3 are arranged at equal intervals in the Y1 direction. Each of the n scanning lines 3 is electrically connected to the gate electrodes of the corresponding transistors 1. The n scanning lines 3 are electrically connected to the scanning line driving circuit 6 illustrated in FIG. 1. As shown in FIG. 3, scanning signals G1, G2, . . . , and Gn are line-sequentially supplied from the scanning line driving circuit 6 to the 1 to n scanning lines 3.

Each of the m data lines 4 extends in the Y1 direction, and the m data lines 4 are arranged at equal intervals in the X1 direction. Each of the m data lines 4 is electrically connected to source regions of the corresponding transistors 1. The m data lines 4 are electrically connected to the data line driving circuit 7 illustrated in FIG. 1. As illustrated in FIG. 3, image signals E1, E2, . . . , and Em are supplied in parallel from the data line driving circuit 7 to the 1 to m data lines 4.

The n scanning lines 3 and the m data lines 4 are electrically insulated from each other and are disposed in a lattice-like pattern in plan view. A region surrounded by two adjacent scanning lines 3 and two adjacent data lines 4 corresponds to a pixel P.

The pixel electrode 10 is provided for each of the pixels P. The pixel electrode 10 is electrically connected to a drain of the transistor 1.

Each of the n capacitance lines 5 extends in the Y1 direction, and the n capacitance lines 5 are arranged at equal intervals in the X1 direction. In addition, the n capacitance lines 5 are electrically insulated from the m data lines 4 and the n scanning lines 3 and are disposed with a gap therebetween. A fixed potential such as a common potential or a ground potential is applied to each of the capacitance lines 5.

One electrode of an auxiliary capacitance 2 is electrically connected to the capacitance line 5. The other electrode of the auxiliary capacitance 2 is electrically connected to the pixel electrode 10 and holds a potential of an image signal supplied to the pixel electrode 10.

1.3. Cross-Sectional Structure of Display Region of Element Substrate

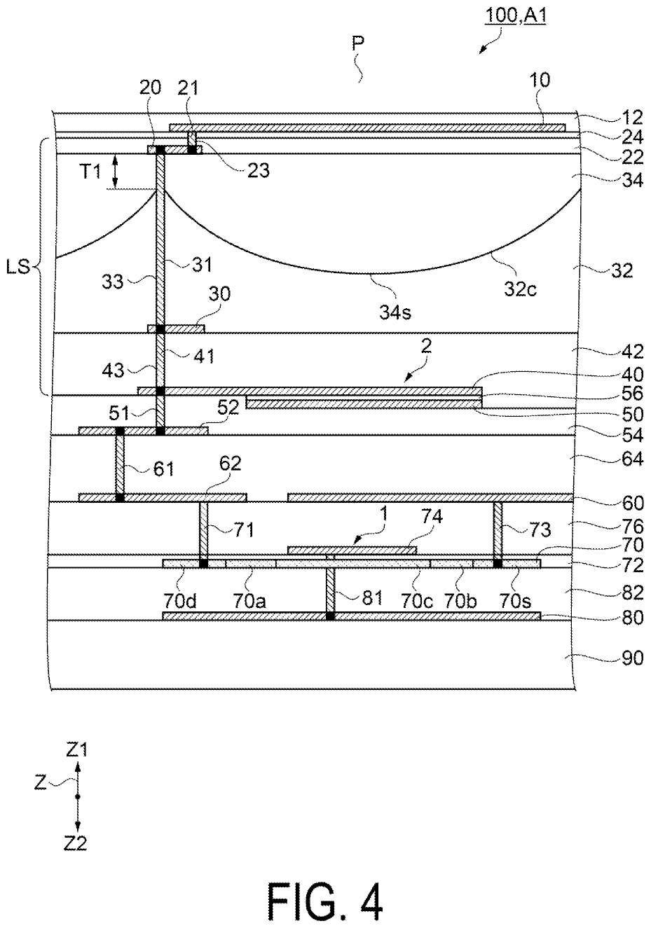

FIG. 4 is an explanatory diagram illustrating a cross-sectional structure of the display region of the element substrate, and illustrates a cross-sectional structure of the pixel P provided in the display region A1.

As illustrated in FIG. 4, in the display region A1, the element substrate 100 has a cross-sectional structure in which insulating or conductive functional layers or functional films are stacked in the Z1 direction of the base body 90.

A light shielding layer 80 is disposed between the base body 90 and the interlayer insulating layer 82.

The light shielding layer 80 is formed of a conductive material having a light shielding property. As the conductive material having a light shielding property, for example, a metal such as tungsten (W), titanium (Ti), chromium (Cr), iron (Fe), or aluminum (Al), a metal nitride, or a metal silicide can be used. The light shielding layer 80 constitutes a part of the scanning line 3. The term “light shielding property” means a light shielding property against visible light, means that a transmittance of visible light is preferably less than 50%, and more preferably 10% or less.

The interlayer insulating layer 82 has a light transmitting property and an insulating property. The interlayer insulating layer 82 is formed of, for example, an inorganic material such as silicon oxide.

The transistor 1 is disposed on the interlayer insulating layer 82.

The transistor 1 includes a semiconductor layer 70 having a lightly doped drain (LDD) structure, a gate electrode 74, and a gate insulating layer 72.

The semiconductor layer 70 has a drain region 70d, an LDD region 70a, a channel region 70c, an LDD region 70b, and a source region 70s.

The channel region 70c is located between the source region 70s and the drain region 70d. The LDD region 70b is located between the channel region 70c and the source region 70s. The LDD region 70a is located between the channel region 70c and the drain region 70d.

The semiconductor layer 70 is made of, for example, polysilicon, and the regions other than the channel region 70c are doped with an impurity for increasing conductivity. An impurity concentration in the LDD region 70b and the LDD region 70a is lower than an impurity concentration in the source region 70s and the drain region 70d.

A gate electrode 74 is provided on the semiconductor layer 70 via a gate insulating layer 72. The gate electrode 74 overlaps the channel region 70c of the semiconductor layer 70.

The gate electrode 74 is formed by, for example, doping polysilicon with an impurity that increases conductivity. The gate electrode 74 may be formed using a conductive material such as a metal, a metal silicide, or a metal compound.

The gate insulating layer 72 is made of, for example, a film of silicon oxide formed by a thermal oxidation method, a chemical vapor deposition (CVD) method, or the like.

The gate electrode 74 and the light shielding layer 80 are electrically connected through a contact hole 81 passing through the gate insulating layer 72 and the interlayer insulating layer 82.

A conductive layer 60 and a relay layer 62 are provided on the transistor 1 via the interlayer insulating layer 76. The conductive layer 60 and the relay layer 62 are provided in the same layer and are formed of a light shielding conductive material. The interlayer insulating layer 76 is formed of the same material as that of the interlayer insulating layer 82.

The conductive layer 60 constitutes a part of the data line 4. The conductive layer 60 is electrically connected to the source region 70s of the semiconductor layer 70 via a contact hole 73 passing through the interlayer insulating layer 76.

The relay layer 62 is electrically connected to the drain region 70d of the semiconductor layer 70 via a contact hole 71 passing through the interlayer insulating layer 76.

An interlayer insulating layer 64 is provided on the conductive layer 60 and the relay layer 62, and a relay layer 52 is provided on the interlayer insulating layer 64. The relay layer 52 is formed of a light shielding conductive material. The interlayer insulating layer 64 is formed of the same material as that of the interlayer insulating layer 82.

The relay layer 52 is electrically connected to the relay layer 62 through a contact hole 61 passing through the interlayer insulating layer 64.

The auxiliary capacitance 2 is provided on the relay layer 52 via an interlayer insulating layer 54.

The auxiliary capacitance 2 includes a capacitance electrode 50 provided on the base body 90 side, a capacitance electrode 40 provided on the pixel electrode 10 side, and a dielectric layer 56 provided between the capacitance electrode 50 and the capacitance electrode 40. Both the capacitance electrode 40 and the capacitance electrode 50 are formed of a light shielding conductive material. The interlayer insulating layer 54 is formed of the same material as that of the interlayer insulating layer 82.

The capacitance electrode 50 constitutes a part of the capacitance line 5.

The capacitance electrode 40 is electrically connected to the relay layer 52 via a contact hole 51 passing through the interlayer insulating layer 54, and is electrically connected to the drain region 70d of the transistor 1.

An optical functional layer LS including the lens layer 34 is provided between the capacitance electrode 40 and the pixel electrode 10.

The optical functional layer LS is provided to curb light amount loss. Specifically, an optical path of transmitted light is adjusted so that the transmitted light that has passed through the pixel electrode 10 is prevented from colliding with a light shielding material layer such as the data line 4 or the capacitance line 5 and causing loss. The optical functional layer LS includes a light transmitting layer 42, a light transmitting layer 32, a lens layer 34, and a light transmitting layer 22.

The light transmitting layer 42 is an optical path length adjusting layer called a path layer for adjusting an optical path length. The light transmitting layer 42 is formed of an inorganic material such as silicon oxide, and an upper surface of the light transmitting layer 42 is planarized by chemical mechanical polishing (CMP) or the like.

The light transmitting layer 32 is a lens forming layer in which a concave portion 32c serving as a lens surface 34s of the lens layer 34 is provided, and is formed of an inorganic material such as silicon oxide similarly to the light transmitting layer 42.

The light transmitting layer 32 includes two light transmitting layers 32a and 32b.

The concave portion 32c of the light transmitting layer 32 is formed by etching the light transmitting layer 32 after the light transmitting layer 32 is formed. Therefore, the light transmitting layer 32 is initially formed to have a thickness of about 10 μm. Since it is difficult to form the light transmitting layer 32 having a thickness of about 10 μm at one time, in the embodiment, the film formation is performed twice, and the light transmitting layer 32 is formed by the light transmitting layer 32a and the light transmitting layer 32b stacked by the film formation performed twice.

The lens layer 34 is provided on the light transmitting layer 32. The lens layer 34 is formed of an inorganic material having a refractive index different from that of the light transmitting layer 32, for example, silicon oxynitride. The lens layer 34 is planarized by CMP or the like after a film of silicon oxynitride is formed to fill the concave portion 32c.

The light transmitting layer 22 is provided on the lens layer 34. The light transmitting layer 22 is an optical path length adjusting layer and is formed of an inorganic material such as silicon oxide similarly to the light transmitting layer 42. A layer thickness of the light transmitting layer 22 is thinner than a layer thickness of the light transmitting layer 32.

A protective layer 24 is provided on the light transmitting layer 22. The protective layer 24 is made of, for example, an inorganic material having light transmitting property and hygroscopicity such as borosilicate glass (BSG). The pixel electrode 10 is provided on the protective layer 24. The alignment film 12 is provided on the pixel electrode 10.

The pixel electrode 10 and the capacitance electrode 40 are electrically connected to each other via a pixel contact plug 21, a relay layer 20, a contact plug 31, a relay layer 30, and a contact plug 41. Thus, the pixel electrode 10 is electrically connected to the drain region 70d of the transistors 1.

The pixel contact plug 21 is provided inside a contact hole 23. The contact hole 23 is provided to extend through the protective layer 24 and the light transmitting layer 22.

The pixel contact plug 21 is formed by filling the inside of the contact hole 23 with a conductive material such as tungsten. The pixel contact plug 21 is in contact with the pixel electrode 10 and the relay layer 20 to electrically connect the pixel electrode 10 and the relay layer 20.

The relay layer 20 is provided between the light transmitting layer 22 and the lens layer 34. When tungsten is used for the pixel contact plug 21, the relay layer 20 is formed of a material, for example, titanium nitride or the like, which provides good electrical conduction with tungsten.

The contact plug 31 is provided inside a contact hole 33. The contact hole 33 is provided to extend through the lens layer 34 and the light transmitting layer 32.

The contact plug 31 is formed by filling the inside of the contact hole 33 with a conductive material such as tungsten. The contact plug 31 is in contact with the relay layer 20 and the relay layer 30 to electrically connect the relay layer 20 and the relay layer 30. Although details will be described below, in the embodiment, the contact hole 33 passes through the relay layer 30 and exposes the contact plug 41 to a bottom surface of the contact hole 33. Therefore, the contact plug 31 is also in contact with the contact plug 41.

The relay layer 30 is provided between the light transmitting layer 32 and the light transmitting layer 42. When tungsten is used for the contact plug 31, the relay layer 30 is formed of a material such as titanium nitride or the like that provides good electrical conduction with tungsten.

The contact plug 41 is provided inside the contact hole 43. The contact hole 43 is provided to extend through the light transmitting layer 42.

The contact plug 41 is formed by filling the inside of the contact hole 43 with a conductive material such as tungsten. The contact plug 41 is in contact with the relay layer 30, the capacitance electrode 40 and the contact plug 31 to electrically connect the relay layer 30 and the contact plug 31 to the capacitance electrode 40.

1.4. Planar Structure of Display Region of Element Substrate

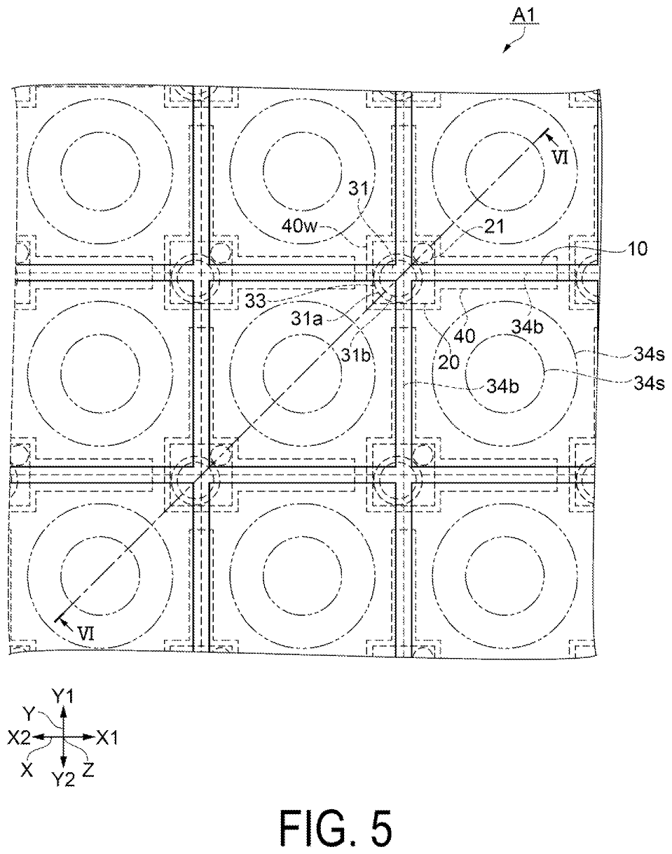

FIG. 5 is a plan view illustrating a part of the display region of the element substrate, and is a view of the display region A1 of the element substrate 100 when seen from the liquid crystal layer Lc side in the Z2 direction. In FIG. 5, the pixel electrode 10 is drawn with a solid line, and a configuration included in the optical functional layer LS provided closer to the base body 90 than the pixel electrode 10 is drawn with a broken line. In addition, in the plan view illustrated below, a curved surface shape of the lens surface 34s is indicated by a double circle of a two dot chain line, and a boundary at which two adjacent lens surfaces 34s are in contact with each other is indicated by a boundary line 34b.

As illustrated in FIG. 5, the pixel electrodes 10 are disposed in a matrix along the X axis and the Y axis.

The pixel contact plug 21 is provided at a position overlapping one of the four corners of the pixel electrode 10, in the embodiment, a lower left corner of the drawing in plan view.

The relay layer 20 has a rectangular shape. Each of the four corners of the relay layer 20 is provided to overlap one of the corners of four pixel electrodes 10 adjacent in the X2 direction, the Y2 direction, and the diagonal direction of the pixel electrodes 10.

The pixel contact plug 21 is provided at a position overlapping the corner of the relay layer 20 in plan view.

The contact plug 31 is provided at a position overlapping the relay layer 20 in plan view. In addition, in the embodiment, the contact plug 31 is provided at a position not overlapping the pixel contact plug 21 in plan view. In order to provide the contact plug 31 so as not to be overlapped contact plug 31 is not overlapped the pixel contact plug 21, the contact plug 31 is provided in the relay layer 20 to be closer to a corner diagonal to the corner at which the pixel contact plug 21 is provided.

When the pixel contact plug 21 is provided at a position not overlapping the contact plug 31 as described above, film formability of the pixel electrode 10 overlapping the pixel contact plug 21 can be improved as compared with a case in which the pixel contact plug 21 is provided at a position overlapping the contact plug 31.

The contact plug 31 has an inverted truncated cone shape. Therefore, an outer edge 31a of an upper surface of the contact plug 31 surrounds the outer side of an outer edge 31b of a bottom surface in plan view.

Although not illustrated, the relay layer 30 is provided in the same size and shape as the relay layer 20. The relay layer 20 and the relay layer 30 substantially completely overlap each other in plan view.

Although not illustrated, the contact plug 41 is provided at a position overlapping the contact plug 31.

Each of the capacitance electrodes 40 includes a wide portion 40w provided at an L-shaped corner, an extending portion extending from the wide portion 40w in the X1 direction to overlap the scanning line 3, and an extending portion extending from the wide portion 40w in the Y1 direction to overlap the date line 4.

The wide portion 40w is provided to overlap the contact hole 33, the contact hole 43, and the contact hole 51. Further, the wide portion 40w is provided in a shape that substantially completely overlaps the relay layer 20.

In the embodiment, an intersection of the boundary line 34b and the contact plug 31 overlap each other. This indicates that the contact plug 31 is provided to extend through the lens surface 34s of the lens layer 34. The boundary line 34b overlapping the inside of the contact hole 33 is originally eliminated when the contact hole 33 is formed in the lens layer 34, but in FIG. 5, the boundary line 34b is illustrated in order to show that the lens surface 34s is provided without a gap.

1.5. Structure of Optical Functional Layer in Display Region of Element Substrate

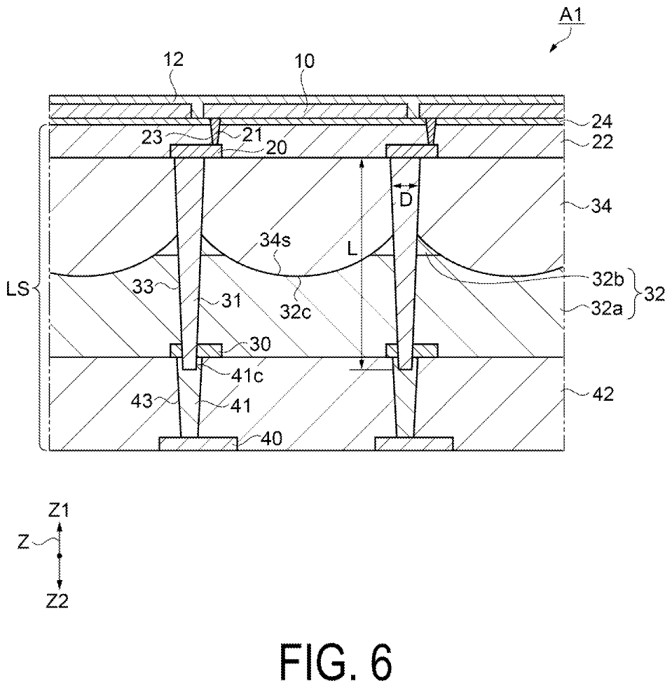

FIG. 6 is a cross-sectional view taken along line VI-VI in FIG. 5 and shows a cross-sectional structure of the optical functional layer LS. As illustrated in FIG. 6, in the embodiment, the contact hole 33 includes a portion passing through the lens layer 34, the light transmitting layer 32, and the relay layer 30, and a concave portion 41c provided in an upper surface of the contact plug 41.

An aspect ratio of the contact hole 33 is about two times or more higher than an aspect ratio of other contact holes, for example, the contact hole 43. In the embodiment, since a depth L of the contact hole 33 is about 5 to 10 μm, and an inner diameter D of the contact hole 33 is about 1 μm, the aspect ratio L/D is about 5 to 10.

The concave portion 41c is formed by over-etching.

The contact hole 33 is formed by anisotropic etching such as dry etching. It is difficult to stop the etching at a position at which the lens layer 34 and the light transmitting layer 32 are penetrated and the relay layer 30 is exposed. Therefore, in the embodiment, over-etching is performed to ensure that the contact hole 33 reaches the relay layer 30. However, since a total layer thickness of a thickness of the lens layer 34 and a thickness of the light transmitting layer 32 to be etched is as thick as 5 to 10 μm, when the etching does not stop at a position of the relay layer 30, the concave portion 41c is formed in the upper surface of the contact plug 41.

As will be described below in detail, the main reason why the concave portion 41c is formed is that the contact holes 33 and a contact hole 133 of the external terminal 9 are formed in the same step in the embodiment.

The time required for forming the contact hole 133 is longer than the time required for forming the contact hole 33. Therefore, when the etching of the contact hole 33 is continued until the formation of the contact hole 133 is completed, the etching for forming the contact hole 33 becomes over-etching. Since the etching for forming the contact hole 33 is over-etching, the etching for forming the contact hole 33 passes through the relay layer 30 and forms the concave portion 41c in the contact plug 41.

In order to ensure electrical connection via the contact hole 33, the contact hole 33 is provided at a position overlapping the contact plug 41 in plan view. As a result, when the contact hole 33 is formed by etching, the bottom of the contact hole 33 is formed in the contact plug 41 even when the contact hole 33 passes through a part of the relay layer 30. That is, the concave portion 41c is formed in the contact plug 41. Therefore, since the contact plug 31 filled in the contact hole 33 is in direct contact with the contact plug 41, the electrical connection between the contact plug 31 and the contact plug 41 can be reliably achieved.

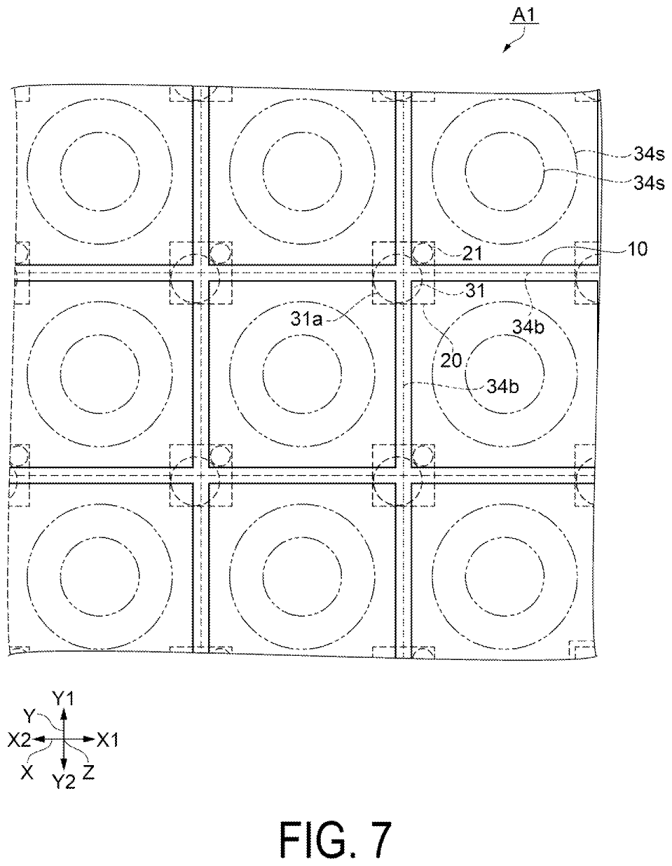

FIG. 7 is a plan view illustrating a part of the display region of the element substrate, and illustrates a layout of the pixel electrode 10, the pixel contact plug 21, the relay layer 20, and the contact plug 31 when the pixel electrode 10 is seen in the Z2 direction in the plan view of the display region A1 of FIG. 5. In FIG. 7, the pixel electrode 10 is indicated with a solid line.

As illustrated in FIG. 7, the pixel contact plug 21 and the contact plug 31 are provided at positions overlapping the relay layer 20 in plan view. The pixel contact plug 21 is provided not to overlap the contact plug 31 in plan view. The pixel contact plug 21 and the contact plug 31 are disposed close to diagonal corners of the relay layer 20 so that the pixel contact plug 21 and the contact plug 31 do not overlap each other in plan view.

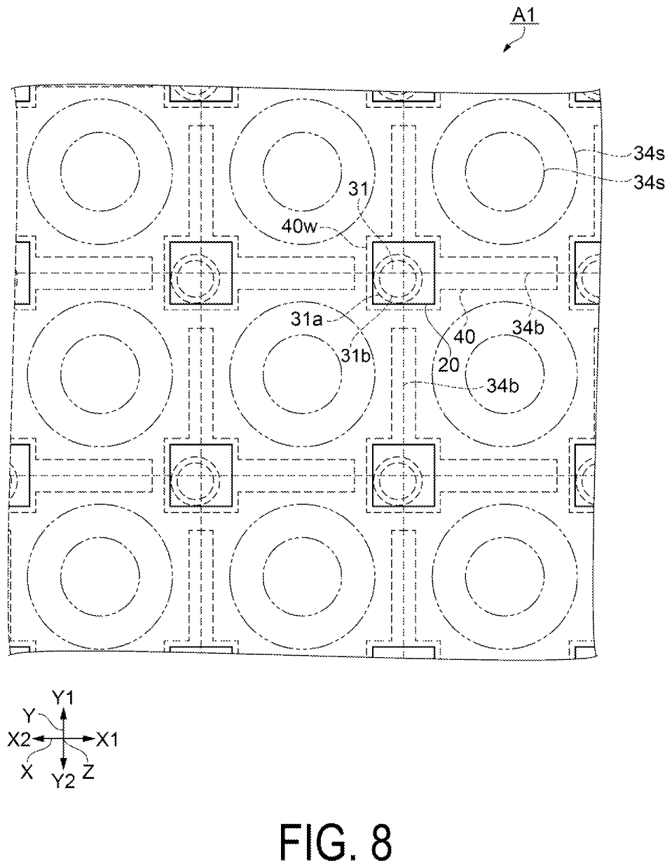

FIG. 8 is a plan view illustrating a part of the display region of the element substrate, and illustrates a layout of the relay layer 20, the contact plugs 31, and the capacitance electrode 40 when the relay layer 20 is seen in the Z2 direction in the plan view of the display region A1 of FIG. 5. In FIG. 8, the relay layer 20 is indicated with a solid line.

As illustrated in FIG. 8, the relay layer 20 substantially completely overlaps the wide portions 40w of the capacitance electrode 40 in plan view. In addition, the relay layer 20 substantially completely overlaps the relay layer 30 (not illustrated) in plan view.

Regarding the boundary line 34b indicating a boundary at which two adjacent lens surfaces 34s are in contact with each other, an intersection of two boundary lines 34b along the X axis and the Y axis is located inside the outer edge 31b and the outer edge 31a of the contact plug 31. Therefore, the contact hole 33 is provided to extend through the lens surface 34s of the lens layer 34.

The lens surface 34s may be formed so that the boundary line 34b and the contact hole 33 do not overlap each other in plan view. In this case, since there is no intersection of the boundary lines 34b, the lens surface 34s is not formed at a position at which the contact hole 33 is provided. Therefore, in this case, the contact hole 33 is provided only in the light transmitting layer 32 between four adjacent lens surfaces 34s.

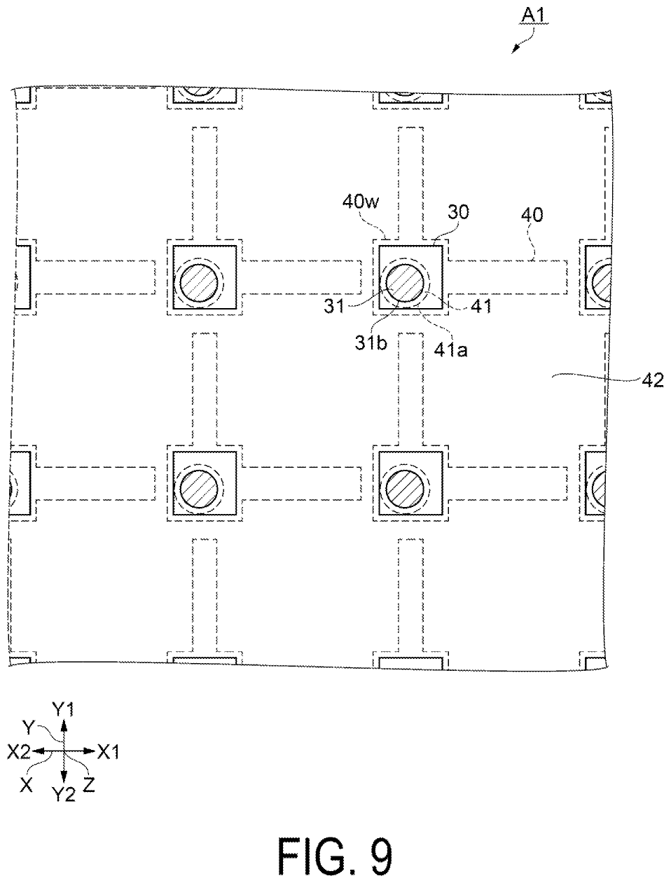

FIG. 9 is a plan view illustrating a part of the display region of the element substrate, and illustrates a layout of the relay layer 30, the contact plug 31, the contact plug 41, and the capacitance electrode 40 when the relay layer 30 is seen in the Z2 direction in the plan view of the display region A1 of FIG. 5. In FIG. 9, the relay layer 30 is indicated with a solid line.

As illustrated in FIG. 9, similarly to the relay layer 20, the relay layer 30 substantially completely overlaps the wide portion 40w of the capacitance electrode 40.

As illustrated in FIG. 9, a cross section of the contact plug 31 passing through the relay layer 30 appears on a surface including the upper surface of the relay layer 30.

The contact plug 31 is provided to overlap the contact plug 41. More specifically, the outer edge 31b of the contact plug 31 on the bottom surface side is provided to be located inside the outer edge 41a of the contact plug 41.

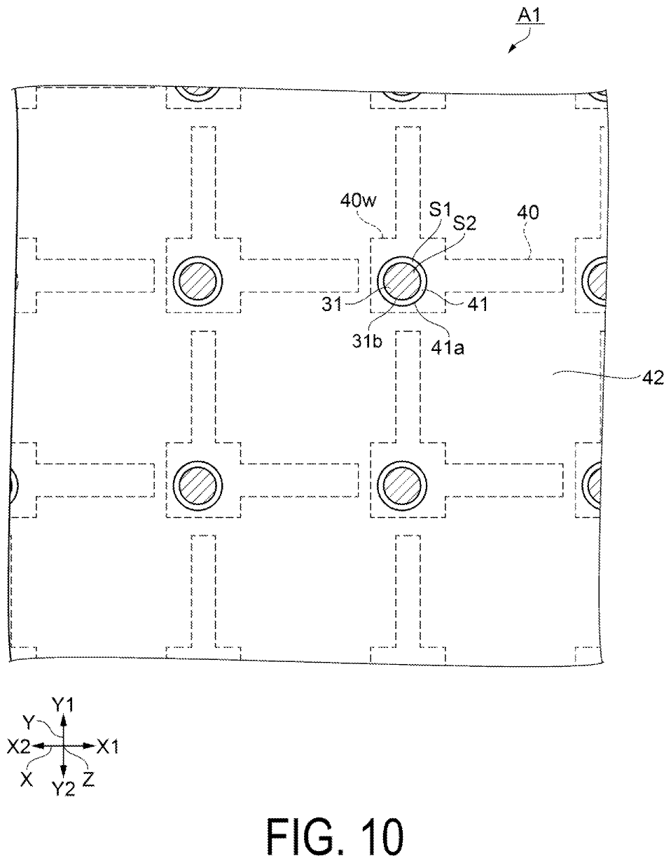

FIG. 10 is a plan view illustrating a part of the display region of the element substrate, and illustrates a layout of the contact plug 41, the contact plug 31, and the capacitance electrode 40 when the upper surface of the contact plugs 41 on the relay layer 30 side is seen in the Z2 direction in the plan view of the display region A1 of FIG. 5. In FIG. 10, the contact plug 41 is indicated with a solid line.

The contact plug 31 is provided to overlap the contact plug 41 and is in contact with the concave portion 41c of the contact plug 41. Therefore, as illustrated in FIG. 10, a cross section of the contact plug 31 filling the concave portion 41c of the contact plug 41 appears on the surface including the upper surface of the contact plug 41 on the relay layer 30 side. Assuming that an area of the cross section of the contact plug 31 is an area S2 and an area surrounded by the outer edge 41a of the upper surface of the contact plug 41 is an area S1, a value of the area S1 is larger than a value of the area S2.

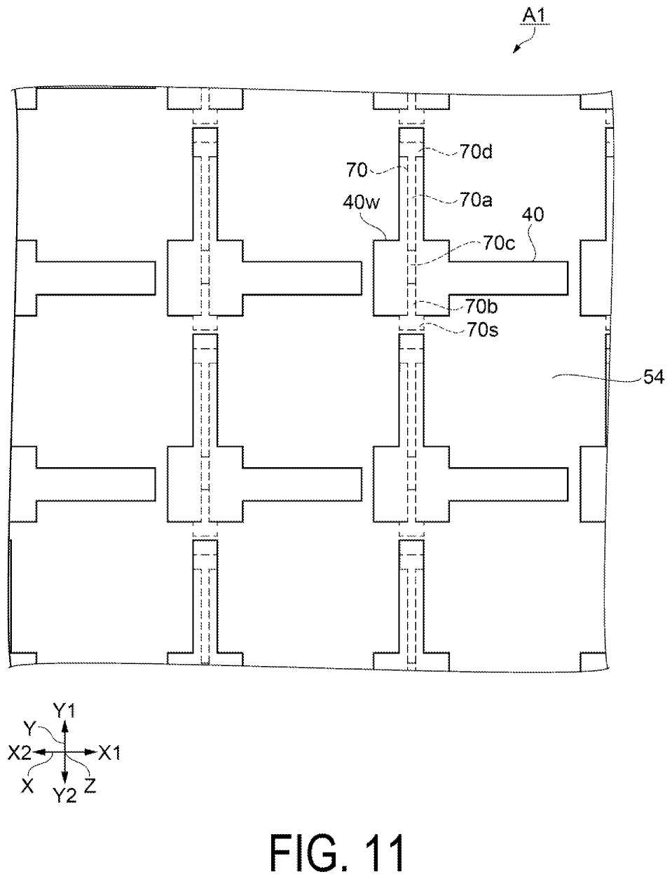

FIG. 11 is a plan view illustrating a part of the display region of the element substrate, and illustrates a layout of the capacitance electrodes 40 and the semiconductor layer 70 when the capacitance electrode 40 is seen in the Z2 direction in the plan view of the display region A1 of FIG. 5. In FIG. 11, the capacitance electrode 40 is indicated with a solid line.

As illustrated in FIG. 11, the capacitance electrode 40 is provided at a position overlapping the semiconductor layer 70 in plan view. The wide portion 40w of the capacitance electrode 40 is provided at a position overlapping the channel region 70c of the semiconductor layer 70 and function as a light shielding layer for the channel region 70c of the semiconductor layer 70.

1.6. Cross-Sectional structure of Outer Region of Element Substrate

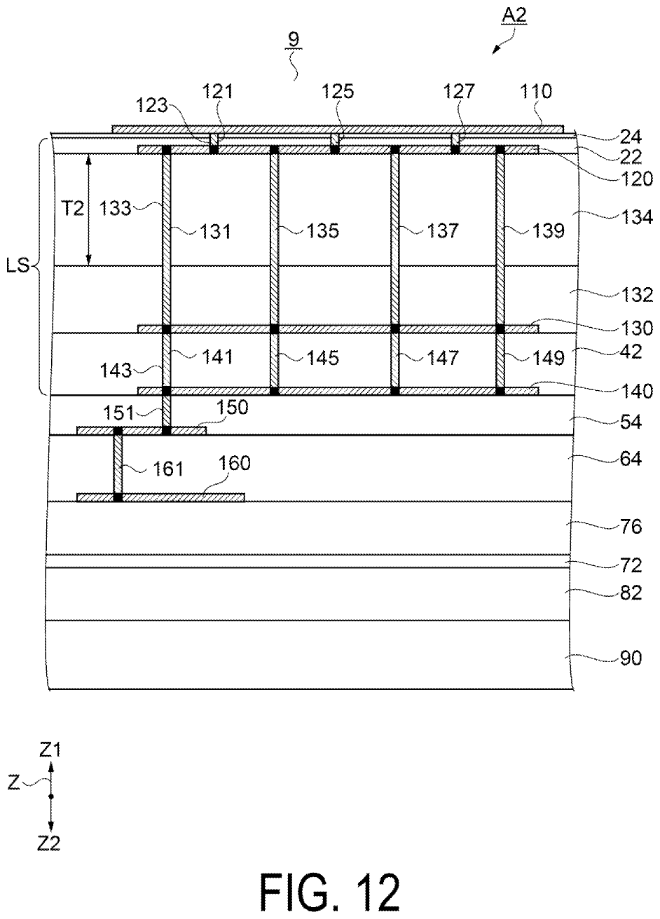

FIG. 12 is an explanatory diagram illustrating a cross-sectional structure of the outer region of the element substrate, and shows a cross-sectional structure of the external terminal 9 provided in the outer region A2. The same components as those illustrated in FIG. 4 are denoted by the same reference numerals, and descriptions thereof will be omitted.

As illustrated in FIG. 12, the external terminal 9 as a terminal includes an electrode pad 110 as a transparent conductive layer in the uppermost layer.

The electrode pad 110 is electrically connected to components provided in the display region A1, such as the capacitance line 5, the scanning line driving circuit 6, and the data line driving circuit 7, via relay layers 120, 130, 140, 150, and 160 provided between the base body 90 and the electrode pad 110, contact plugs 121, 125, and 127 provided between the electrode pad 110 and the relay layer 120, contact plugs 131, 135, 137, and 139 provided between the relay layers 120 and 130, contact plugs 141, 145, 147, and 149 provided between the relay layers 130 and 140, a contact plug 151 provided between the relay layers 140 and 150, and a contact plug 161 provided between the relay layers 150 and 160.

The electrode pad 110 is provided in the same layer as the pixel electrode 10. The electrode pad 110 is formed by the same step and with the same material as the pixel electrode 10.

A contact hole 123 is provided in the same layer as the contact hole 23. The contact hole 123 is formed in the same step as the contact hole 23.

The contact plug 121 filling the contact hole 123 is formed by the same step and with the same material as the pixel contact plug 21. The contact plugs 125 and 127 are formed in the same manner as the contact plug 121.

The relay layer 120 is provided in the same layer as the relay layer 20. The relay layer 120 is formed by the same step and with the same material as the relay layer 20.

The relay layer 130 is provided in the same layer as the relay layer 30. The relay layer 130 is formed by the same step and with the same material as the relay layer 30.

An interlayer insulating layer 132 and an interlayer insulating layer 134 are provided between the relay layer 120 and the relay layer 130.

The interlayer insulating layer 132 is provided in the same layer as the light transmitting layer 32. The interlayer insulating layer 132 is formed by the same step and with the same material as the light transmitting layer 32. The interlayer insulating layer 132 is etched back and planarized by etching for forming the concave portion 32c after the film formation. The concave portion 32c is not formed in the interlayer insulating layer 132.

The interlayer insulating layer 134 is formed at the interlayer insulating layer 132. The interlayer insulating layer 134 is formed by the same step and with the same material as the lens layer 34.

An interlayer thickness between the relay layer 120 and the relay layer 130 is substantially the same as an interlayer thickness between the relay layer 20 and the relay layer 30, but the interlayer insulating layer 134 and the lens layer 34 have different layer thicknesses. More specifically, a value of a thickness T2 of the interlayer insulating layer 134 is larger than a thickness T1 of the lens layer 34 at a position at which the contact hole 33 illustrated in FIG. 4 is provided.

The contact hole 133 is formed in the same step as the contact hole 33. The contact plug 131 filling the contact hole 133 is formed by the same step and with the same material as the contact plug 31. The contact plugs 135, 137, and 139 are formed in the same manner as the contact plug 131.

The relay layer 140 is provided in the same layer as the capacitance electrode 40. The relay layer 140 is formed by the same step and with the same material as the capacitance electrode 40.

The contact hole 143 is provided in the same layer as the contact hole 43. The contact hole 143 is formed in the same step as the contact hole 43. The contact plug 141 filling the contact hole 143 is formed by the same step and with the same material as the contact plug 41. The contact plugs 145, 147, and 149 are formed in the same manner as the contact plug 141.

1.7. Planar Structure of Outer Region of Element Substrate

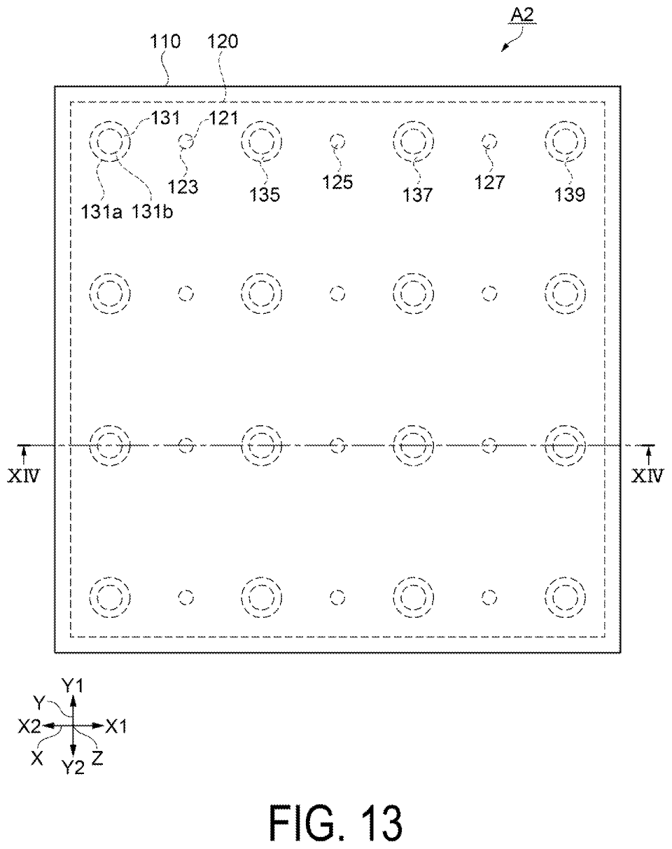

FIG. 13 is a plan view illustrating a part of the outer region of the element substrate, and is a view of the external terminal 9 in the outer region A2 of the element substrate when seen in the Z2 direction.

As illustrated in FIG. 13, the contact plugs 121, 125, and 127 are disposed at positions not overlapping the contact plugs 131, 135, 137, and 139.

Similarly to the contact plug 31, the contact plug 131 has an inverted truncated cone shape. Therefore, an outer edge 131a of an upper surface of the contact plug 131 is provided to surround the outer side of an outer edge 131b of a bottom surface of the contact plug 131 in plan view.

1.8. Structure of Optical Functional Layer in Outer Region of Element Substrate

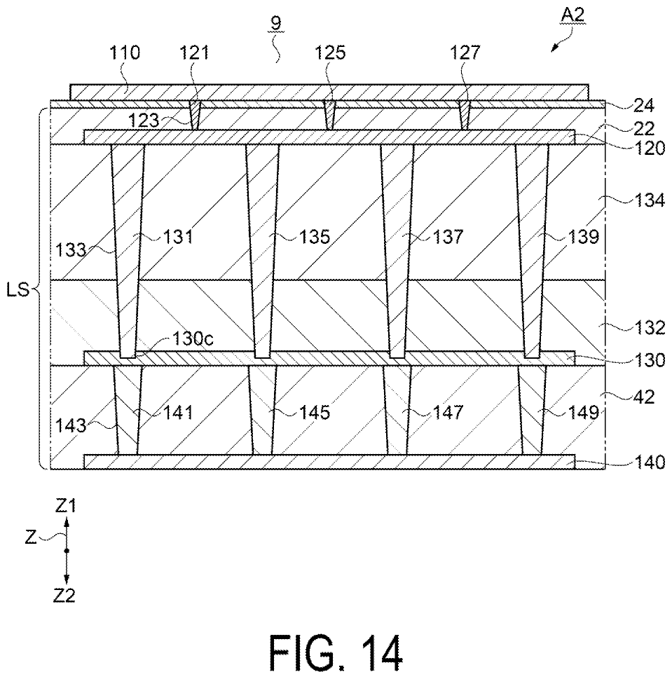

FIG. 14 is a cross-sectional view taken along line XIV-XIV in FIG. 13 and shows a cross-sectional structure of the optical functional layer LS in the outer region A2.

As illustrated in FIG. 14, in the embodiment, the contact hole 133 includes the interlayer insulating layer 134, the interlayer insulating layer 132, and a concave portion 130c provided in the relay layer 130.

The concave portion 130c is formed by over-etching. This is because, although the contact hole 133 is formed by anisotropic etching such as dry etching, the layer thickness of the interlayer insulating layer 134 and the interlayer insulating layer 132 is as thick as 5 to 10 μm, and it is difficult to stop the etching at a position at which the relay layer 130 is exposed.

Further, as described above, the contact hole 133 is formed in the same step as the contact hole 33.

A total layer thickness of a thickness of the interlayer insulating layer 134 and a thickness of the interlayer insulating layer 132 through which the contact hole 133 passes is substantially the same as a total layer thickness of a thickness of the lens layer 34 and a thickness of the light transmitting layer 32 through which the contact hole 33 passes, but the contact hole 133 and the contact hole 33 have different ratios between the thickness of the lens layer and the thickness of the light transmitting layer through which the contact hole 133 and the contact hole 33 pass.

Specifically, as illustrated in FIGS. 4 and 12, a thickness T2 of the interlayer insulating layer 134 is thicker than a thickness T1 of the lens layer 34. Since the lens layer 34 and the interlayer insulating layer 134 are formed of a material having a lower etching rate than the light transmitting layer 32 and the interlayer insulating layer 132, a longer etching time is required for forming the contact hole 133 than for forming the contact hole 33.

Therefore, when the etching of the contact hole 33 is continued until the formation of the contact hole 133 is completed, the etching for forming the contact hole 33 passes through the relay layer 30 and forms a concave portion 41c in the upper surface of the contact plug 41.

Although the example in which the contact plug 31 passes through the lens surface 34s of the lens layer 34 has been described in the embodiment, the contact plug 31 may not extend through the lens layer 34. Specifically, only the light transmitting layer 32 may be penetrated.

Even in this case, since the contact hole 133 and the contact hole 33 have a different ratio of the thickness of the interlayer insulating layer 134 to the thickness of the interlayer insulating layer 132 and a different ratio of the thickness of the lens layer 34 to the light transmitting layer 32, the etching for forming the contact hole 133 requires a longer time than that for forming the contact hole 33. Therefore, the contact hole 33 passes through the relay layer 30 by the etching for forming the contact hole 33, and the concave portion 41c is formed in the contact plug 41.

As described above, the liquid crystal device 300 as the electro-optical device according to the embodiment includes the transistor 1, the pixel electrode 10 provided corresponding to the transistor 1, the lens layer 34 provided between the transistor 1 and the pixel electrode 10, the relay layer 30 provided in a layer between the transistor 1 and the lens layer 34, and the contact plug 31 for electrically connecting the relay layer 30 and the pixel electrode 10, and a part of the contact plug 31 is provided inside the relay layer 30.

Thus, a part of the contact plug 31 is provided inside the relay layer 30. Therefore, it is possible to improve the reliability of the electrical connection between the pixel electrode 10 and the transistor 1.

The liquid crystal device 300 according to the embodiment further includes the light transmitting layer 32 provided in a layer between the relay layer 30 and the lens layer 34, and the contact plug 31 is provided inside the contact hole 33 passing through the lens layer 34 and the light transmitting layer 32.

As described above, the contact plug 31 is provided inside the contact hole 33 passing through the lens layer 34 and the light transmitting layer 32. Therefore, it is possible to achieve both the optical performance of the lens layer 34 and the reliability of the electrical connection between the pixel electrode 10 and the transistor 1.

The liquid crystal device 300 of the embodiment further includes a light transmitting layer 22 thinner than the light transmitting layer 32 in a layer between the lens layer 34 and the pixel electrode 10, a relay layer 20 provided in a layer between the lens layer 34 and the light transmitting layer 22, and a pixel contact plug 21 for electrically connecting the relay layer 20 and the pixel electrode 10, and the pixel contact plug 21 is provided not to overlap the contact plug 31 in plan view.

In this manner, the pixel contact plug 21 is provided not to overlap the contact plug 31 in plan view. Therefore, the film formability of the pixel electrode 10 can be improved.

In the liquid crystal device 300 according to the embodiment, the pixel contact plug 21 is provided inside a contact hole 23 passing through the light transmitting layer 22.

As described above, the pixel contact plug 21 is provided inside the contact hole 23 passing through the light transmitting layer 22. Therefore, it is possible to achieve both the optical performance of the optical functional layer LS including the light transmitting layer 22 and the reliability of the electrical connection between the pixel electrode 10 and the transistor 1.

The liquid crystal device 300 according to the embodiment further includes the capacitance electrode 40 as the light shielding layer having the wide portion 40w overlapping the semiconductor layer 70 of the transistor 1 in plan view and the contact plug 41 for electrically connecting the capacitance electrode 40 and the relay layer 30, and the contact plug 41 is provided at a position overlapping the contact plug 31 in plan view.

As described above, the contact plug 41 is provided at a position overlapping the contact plug 31 in plan view. Therefore, even when the contact plug 31 passes through the relay layer 30, the contact plug 31 and the contact plug 41 can be reliably electrically connected to each other.

The liquid crystal device 300 according to the embodiment further includes the light transmitting layer 42 in a layer between the relay layer 30 and the capacitance electrode 40, and the contact plug 41 is provided inside the contact hole 43 passing through the light transmitting layer 42.

As described above, the contact plug 41 is provided inside the contact hole 43 passing through the light transmitting layer 42. Therefore, it is possible to achieve both the optical performance of the optical functional layer LS including the light transmitting layer 42 and the reliability of the electrical connection between the pixel electrode 10 and the transistor 1.

In the liquid crystal device 300 according to the embodiment, the area S1 of the contact plug 41 on the relay layer 30 side is larger than the area S2 of the contact plug 31 on the relay layer 30 side.

As described above, the area S1 of the contact plug 41 on the relay layer 30 side is larger than the area S2 of the contact plug 31 on the relay layer 30 side. Therefore, even when the contact plug 31 passes through the relay layer 30, the contact plug 31 and the contact plug 41 can be reliably electrically connected to each other.

The liquid crystal device 300 according to the embodiment further includes, in the outer region A2 outside the display region A1 in which the pixel electrodes 10 are provided, an external terminal 9 as a terminal including the relay layer 130 provided in the same layer as the relay layer 30, the electrode pad 110 provided in the same layer as the pixel electrode 10 and serving as a transparent conductive layer, and the contact plug 131 provided in the same layer as the contact plugs 31 and electrically connecting the electrode pad 110 and the relay layer 130.

As described above, particularly, the external terminal 9 includes the contact plug 131 in the same layer as the contact plug 31. Therefore, similarly to the electrical connection between the pixel electrode 10 and the transistor 1, it is possible to improve the reliability of the electrical connection between the electrode pad 110 and the relay layer 130.

The liquid crystal device 300 according to the embodiment further includes the interlayer insulating layer 134 provided in the same layer as the lens layer 34 between the electrode pad 110 as the transparent conductive layer and the relay layer 130, and the contact plug 131 is provided inside the contact hole 133 passing through the interlayer insulating layer 134.

As described above, the contact plug 131 is provided inside the contact hole 133 passing through the interlayer insulating layer 134. Therefore, similarly to the electrical connection between the pixel electrode 10 and the transistor 1, it is possible to reliably electrically connect the electrode pad 110 and the relay layer 130 by the contact plug 131.

In the liquid crystal device 300 according to the embodiment, the thickness of the lens layer 34 through which the contact hole 33 passes is smaller than the thickness of the interlayer insulating layer 134 through which the contact hole 133 passes.

As described above, the thickness of the lens layer 34 through which the contact hole 33 passes is smaller than the thickness of the interlayer insulating layer 134 through which the contact hole 133 passes. Therefore, the reliability of the electrical connection between the pixel electrode 10 and the transistor 1 and as well as the reliability of the electrical connection between the electrode pad 110 and the relay layer 130 can also be satisfactorily ensured by providing a part of the contact plug 31 inside the relay layer 30.

In the liquid crystal device 300 according to the embodiment, the contact plug 31 is provided to extend through the relay layer 30, and a part of the contact plug 131 is provided inside the relay layer 130.

As described above, the contact plug 31 is provided to extend through the relay layer 30, and a part of the contact plug 131 is provided inside the relay layer 130. Therefore, it is possible to secure the reliability of the electrical connection between the pixel electrode 10 and the transistor 1 as well as the reliability of the electrical connection between the electrode pad 110 and the relay layer 130.

### 2. Embodiment 2

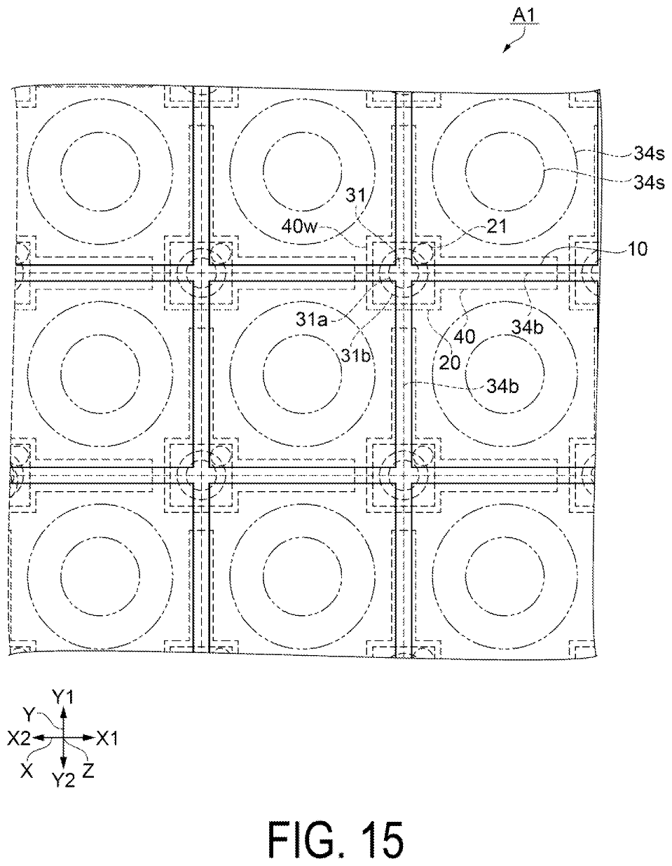

A structure of a liquid crystal device as an electro-optical device according to Embodiment 2 will be described with reference to FIG. 15. FIG. 15 is a plan view illustrating a part of a display region of an element substrate according to Embodiment 2. Embodiment 2 is different from Embodiment 1 in the position at which the contact plug 31 is provided. The same reference numerals are given to the same configurations as in Embodiment 1, and the description thereof will be omitted.

As illustrated in FIG. 15, the contact plug 31 is provided at a substantially central position of the relay layer 20 in plan view. The pixel contact plug 21 is provided at a position overlapping the contact plug 31 in plan view. Further, the contact plug 31 is provided at a position substantially completely overlapping the contact plug 41 (not illustrated) in plan view.

When a part of the pixel contact plug 21 is disposed to overlap the contact plug 31 as described above, alignment between the pixel contact plug 21 and the contact plug 31 can be performed more easily than when the pixel contact plug 21 and the contact plug 31 are disposed not to overlap each other.

Further, since the contact plug 31 is provided at a substantially central position of the relay layer 20, a size of the relay layer 20 can be reduced. Similarly, it is possible to reduce a light shielding region and to increase an opening region through which light passes by reducing a size of the relay layer 30 and the wide portion 40w of the capacitance electrode 40.

As described above, according to the liquid crystal device 300 as the electro-optical device of the embodiment, the following effects can be obtained in addition to the effects of the above embodiment.

The liquid crystal device 300 according to the embodiment further includes a light transmitting layer 22 thinner than the light transmitting layer 32 in a layer between the lens layer 34 and the pixel electrode 10, a relay layer 20 provided in a layer between the lens layer 34 and the light transmitting layer 22, and a pixel contact plug 21 for electrically connecting the relay layer 20 and the pixel electrode 10, and the pixel contact plug 21 is provided to partially overlap the contact plug 31 in plan view.

In this manner, the pixel contact plug 21 is provided to partially overlap the contact plug 31 in plan view. Therefore, the pixel contact plug 21 and the contact plug 31 can be easily aligned with each other. In addition, the sizes of the relay layer 20, the relay layer 30, and the wide portion 40w of the capacitance electrode 40 can be reduced to reduce the light shielding region, and thus the opening region through which light passes can be increased.

### 3. Embodiment 3

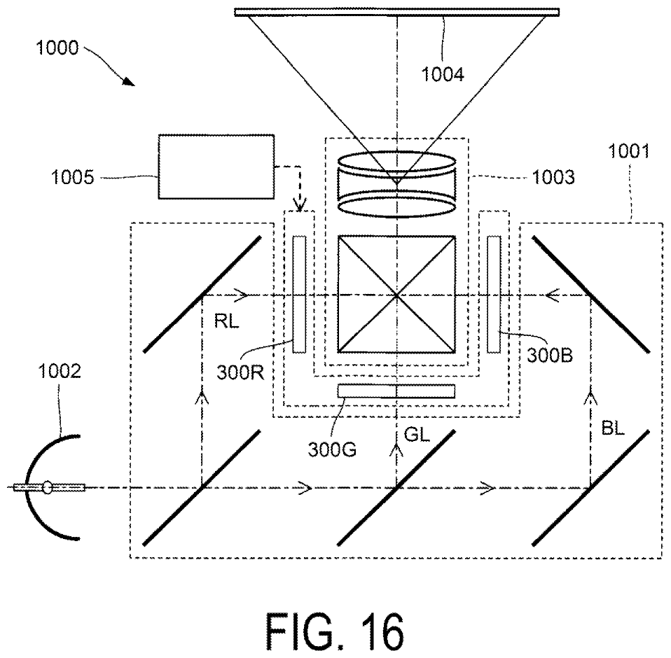

FIG. 16 is a schematic diagram showing a projector as a projection display device, which is an example of the electronic apparatus.

The projector 1000 is, for example, a three plate type projector including three liquid crystal devices 300 described above. A liquid crystal device 300R corresponds to a red display color, a liquid crystal device 300G corresponds to a green display color, and a liquid crystal device 300B corresponds to a blue display color. A control unit 1005 includes, for example, a processor and a memory, and controls operations of the liquid crystal devices 300R, 300G, and 300B.

An illumination optical system 1001 supplies a red element RL of light emitted from an illumination device 1002 as a light source to the liquid crystal device 300R, a green element GL of the light to the liquid crystal device 300G, and a blue element BL of the light to the liquid crystal device 300B. Each of the liquid crystal devices 300R, 300G, and 300B functions as a light modulation device that modulates each color light RL, GL, and BL supplied from the illumination optical system 1001 according to a display image.

A projection optical system 1003 combines emission light from each of the liquid crystal devices 300R, 300G, and 300B and projects the combined light onto a projector screen 1004.

As described above, the projector 1000 as the electronic apparatus according to the embodiment includes the liquid crystal device 300 described above.

Therefore, it is possible to improve performance of the projector 1000 by adopting the liquid crystal device 300 having high optical performance and high electrical reliability.

The electronic apparatus is not limited to the illustrated three plate type projector 1000. For example, the projector may be a single plate type projector, a double plate type projector, or a projector including four or more liquid crystal devices 300. Further, the electric apparatus may be personal digital assistants (PDA), digital still cameras, televisions, video cameras, car navigation apparatuses, in-vehicle displays, electronic organizers, electronic paper, calculators, word processors, workstations, videophones, point-of-sale (POS), printers, scanners, copiers, video players, or equipment including a touch panel.

Although preferred embodiments have been described above, the present disclosure is not limited to the above-described embodiments. In addition, the configuration of each component of the present disclosure may be replaced with any configuration that exerts the equivalent functions of the above-described embodiments, and to which any configuration may be added.

What is claimed is:

1. An electro-optical device comprising:
a transistor;
a pixel electrode provided corresponding to the transistor;
a lens layer provided in a layer between the transistor and the pixel electrode;
a first relay layer provided in a layer between the transistor and the lens layer; and
a first connecting member configured to electrically connect the first relay layer and the pixel electrode, wherein a part of the first connecting member is provided inside the first relay layer.

2. The electro-optical device according to claim 1 further comprising a first light transmitting layer provided in a layer between the first relay layer and the lens layer, wherein
the first connecting member is provided inside a first contact hole extending through the lens layer and the first light transmitting layer.

3. The electro-optical device according to claim 2, further comprising:
a second light transmitting layer disposed in a layer between the lens layer and the pixel electrode, the second light transmitting layer being thinner than the first light transmitting layer;
a second relay layer provided in a layer between the lens layer and the second light transmitting layer; and
a second connecting member configured to electrically connect the second relay layer and the pixel electrode, wherein
the second connecting member is provided not to overlap the first connecting member in plan view.

4. The electro-optical device according to claim 3, wherein
the second connecting member is provided inside a second contact hole extending through the second light transmitting layer.

5. The electro-optical device according to claim 3, further comprising:
a light shielding layer having a wide portion overlapping a semiconductor layer of the transistor in plan view; and
a third connecting member configured to electrically connect the light shielding layer and the first relay layer, wherein
the third connecting member is provided at a position overlapping the first connecting member in plan view.

6. The electro-optical device according to claim 5, further comprising a third light transmitting layer provided in a layer between the first relay layer and the light shielding layer, wherein
the third connecting member is provided inside a third contact hole extending through the third light transmitting layer.

7. The electro-optical device according to claim 5, wherein
an area of the third connecting member on a first relay layer side is larger than an area of the first connecting member on the first relay layer side.

8. The electro-optical device according to claim 2, further comprising a terminal including:
a first conductive layer provided in the same layer as the first relay layer outside a display region in which the pixel electrode is provided;
a transparent conductive layer provided in the same layer as the pixel electrode; and
a fourth connecting member provided in the same layer as the first connecting member to electrically connect the transparent conductive layer and the first conductive layer.

9. The electro-optical device according to claim 8, further comprising, between the transparent conductive layer and the first conductive layer, an interlayer insulating layer provided in the same layer as the lens layer, wherein
the fourth connecting member is provided inside a fourth contact hole extending through the interlayer insulating layer.

10. The electro-optical device according to claim 9, wherein
a thickness of the lens layer through which the first contact hole extends is smaller than a thickness of the interlayer insulating layer through which the fourth contact hole extends.

11. The electro-optical device according to claim 8, wherein
the first connecting member is provided to extend through the first relay layer, and a part of the fourth connecting member is provided inside the first conductive layer.

12. The electro-optical device according to claim 2, further comprising:
a second light transmitting layer disposed in a layer between the lens layer and the pixel electrode, the second light transmitting layer being thinner than the first light transmitting layer;
a second relay layer provided in a layer between the lens layer and the second light transmitting layer; and
a second connecting member configured to electrically connect the second relay layer and the pixel electrode, wherein a part of the second connecting member is provided to overlap the first connecting member in plan view.

13. An electronic apparatus comprising the electro-optical device according to claim 1.
